(19) United States
(12) Patent Application Publication
(10) Pub. No.: US 2007/0022439 A1
(43) Pub. Date: Jan. 25, 2007

(54) Display apparatus for automatically classifying recorded programs and method thereof

(75) Inventors: In Hoon Kim, Dong-gu (KR); Hae Woo Jang, Suseong-gu (KR)

Correspondence Address: FLESHNER & KIM, LLP, P.O. BOX 221200, CHANTILLY, VA, 20153, US

(73) Assignee: LG Electronics Inc.

(21) Appl. No.: 11/483,517

(22) Filed: Jul. 11, 2006

(30) Foreign Application Priority Data
Jul. 19, 2005 (KR) 10-2005-0065405

(51) Int. Cl. H04N 7/173; H04N 5/445; H04N 7/167; G06F 3/00; G06F 13/00

(52) U.S. Cl. 725/45; 725/31; 725/100

(57) ABSTRACT

A display device for automatically classifying programs and the method thereof is disclosed. The present invention includes a display device for automatically classifying a program to be stored comprising a decoder for decoding transport streams of the program to be stored and retrieving a rating information of the program to be stored during the decoding, a storage for storing the program and the rating information of the program, and a controller for automatically storing the program according to the rating information. Also, a method for automatically classifying a program to be stored comprises decoding transport streams of the program to be stored, retrieving a rating information of the program to be stored during the decoding, and automatically storing the program according to the rating information.

This application claims the benefit of Korean Patent Application No. 10-2005-0065405, filed on Jul. 19, 2005, which is hereby incorporated by reference.

### BACKGROUND OF THE INVENTION

1. Field of the Invention

The present invention relates to a display device, and more particularly, to a display device for automatically classifying recorded programs and method thereof.

2. Discussion of the Related Art

Heretofore every recorded program was stored on a storage area without any classification. If a user wanted to organize recorded programs by genre and/or rating, the user manually created folders and moved the recorded programs to the corresponding folders. Also, every folder including recorded programs was accessible to every person who wanted to see it without any restrictions.

Therefore, it is highly desired to develop a display device for automatically classifying recorded programs which prevent from manually classifying the recorded programs and from accessing to a person who doesn't have a right to see it.

### SUMMARY OF THE INVENTION

Accordingly, the present invention is directed to a display device for automatically classifying programs and the method thereof that substantially obviates one or more problems due to the limitations and disadvantages of the related art.

An object of the present invention is to provide more convenient user interface to the user by automatically classifying recorded programs according to the rating information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a display device for automatically classifying a program to be stored is provided that comprises a decoder for decoding transport streams of the program to be stored and retrieving a rating information of the program to be stored during the decoding, a storage for storing the program and the rating information of the program, and a controller for automatically storing the program according to the rating information.

In another aspect of the present invention, a method for automatically classifying a program to be stored is provided that comprises decoding transport streams of the program to be stored, retrieving a rating information of the program to be stored during the decoding, and automatically storing the program according to the rating information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a block diagram of a display device having an automatic classifying function of recorded programs;

FIG. 2 illustrates a display screen which shows a list of folders for recorded programs;

FIG. 3 illustrates a display screen which shows a list of folders for recorded programs with an “Other’ folder;

FIG. 4 illustrates a display screen which shows configuration of the automatic classifying function;

FIG. 5 illustrates a display screen which shows a list of folders for recorded programs without displaying restricted folders; and

FIG. 6 illustrates a flowchart illustrating the method steps of automatically classifying recorded programs.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

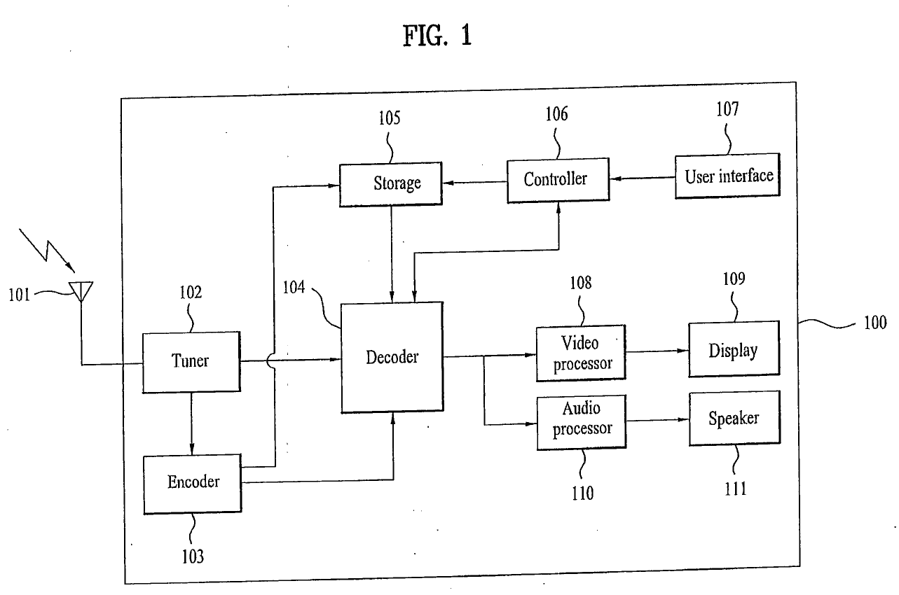

FIG. 1 shows a display device (100) having an automatic classifying function of recorded programs. An antenna (101) receives specific broadcasting signals in a tuned frequency range. The tuner (102) demodulates IF signals from the received broadcasting signals. The encoder (103) converts analog signals from the antenna (101) to digital signals.

The decoder (104) decodes signals in the form of transport streams to further process at the video processor (108) or the audio processor (110). Also, the decoder (104) retrieves the rating information from the received broadcasting signals. The decoder (104) may include a system decoder, a video signal decoder and an audio signal decoder.

The rating information includes the Genre Descriptor according to the Program and System Information Protocol (PSIP) standard from the Advanced Television System Committee (ATSC). The Genre Descriptor provides genre, program type or category information for programs. However, the rating information is not limited to the PSIP standard, but includes any genre information contained in the broadcasting signals.

The storage (105) stores the broadcasting signals and the retrieved rating information. The controller (106) decides which signals are stored at the storage (105) and which signals are retrieved from the storage (105). The user interface (107) provides specific commands from the user. The user interface (107) includes any kinds of user inputs such as keypad, mouse and remote control. The display (109) displays signals from the video processor (108) and the speaker (111) outputs the signals from the audio processor (110).

Now, operations of automatically classifying recorded programs using the rating information are explained. After a user inputs a command to record a specific program, the controller (106) controls the decoder (104) and the storage (105) to store the specific program at the storage (105). The decoder (104) retrieves the rating information while recording the specific program.

And then the controller (106) controls the storage (105) to store the specific program at a folder corresponding to the rating information. For example, if the rating information of a program is “movie,” the program is stored at a folder named “movie.” The controller (106) creates a new folder if the folder corresponding to the rating information does not exist.

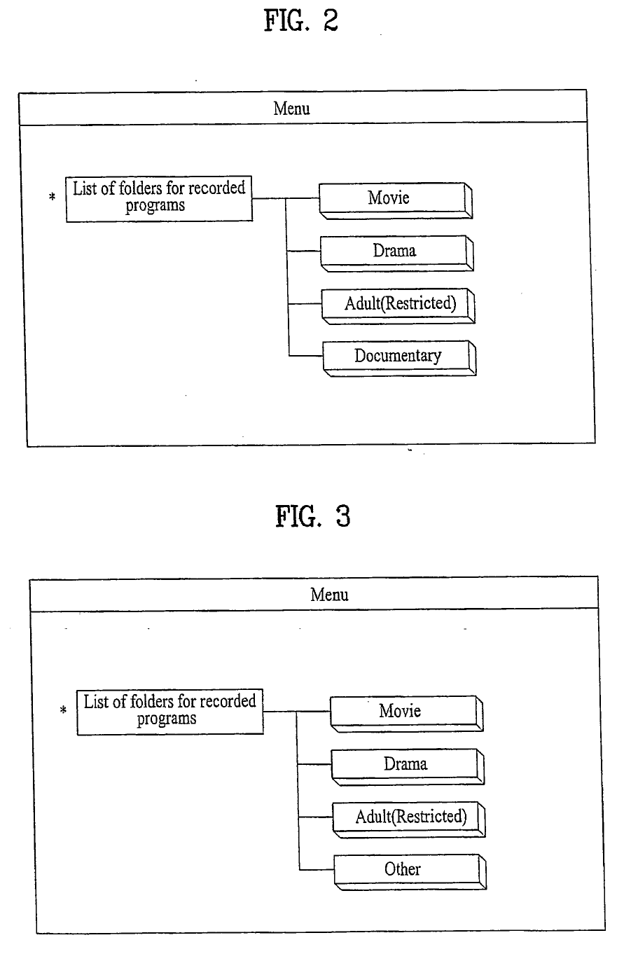

FIG. 2 and FIG. 3 illustrate a display screen which shows a list of folders for recorded programs. When the rating information of a program shows that the genre is “documentary” but there is no “documentary” folder, the controller (106) creates a folder named “documentary” as shown in FIG. 2 or creates a folder named “other” as shown in FIG. 3 to temporarily store the “documentary” program at the “other” folder.

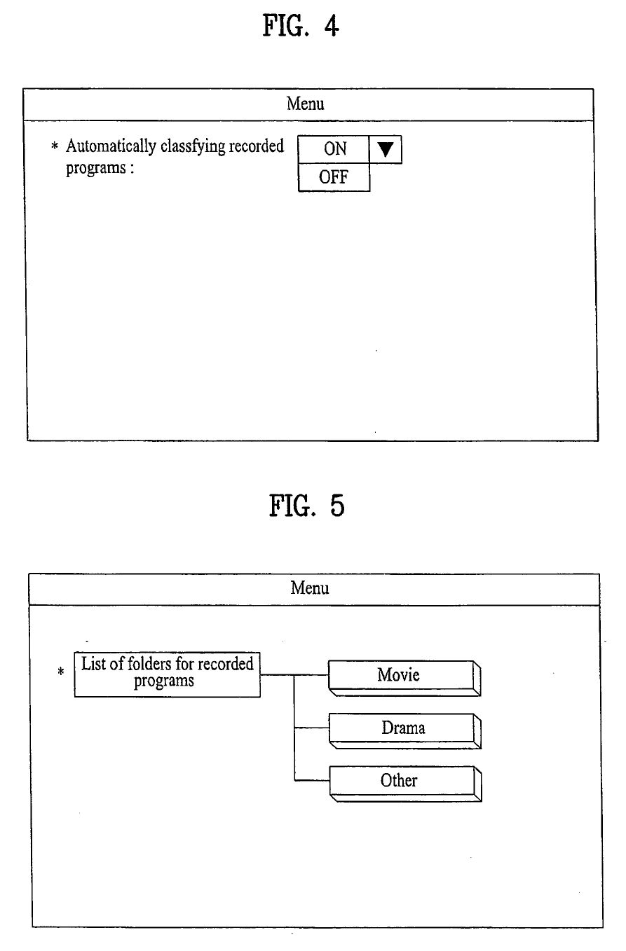

FIG. 4 illustrates a display screen which shows the configuration of the automatic classifying function. The automatic classifying function can be turned on and off as a user wants. When the automatic classifying function is on, the display device (100) automatically classify recorded programs corresponding to the rating information. When the user wants to differently classify recorded programs than the automatic classification of the display device, the user also can turn off the automatic classifying function.

Moreover, the user can create one or more restricted folders and set up a password for objectionable or sensitive programs such as sex, violence, strong language and nudity. When the restricted folders are created, the controller (106) controls the display (109) not to display the restricted folders as shown in FIG. 5.

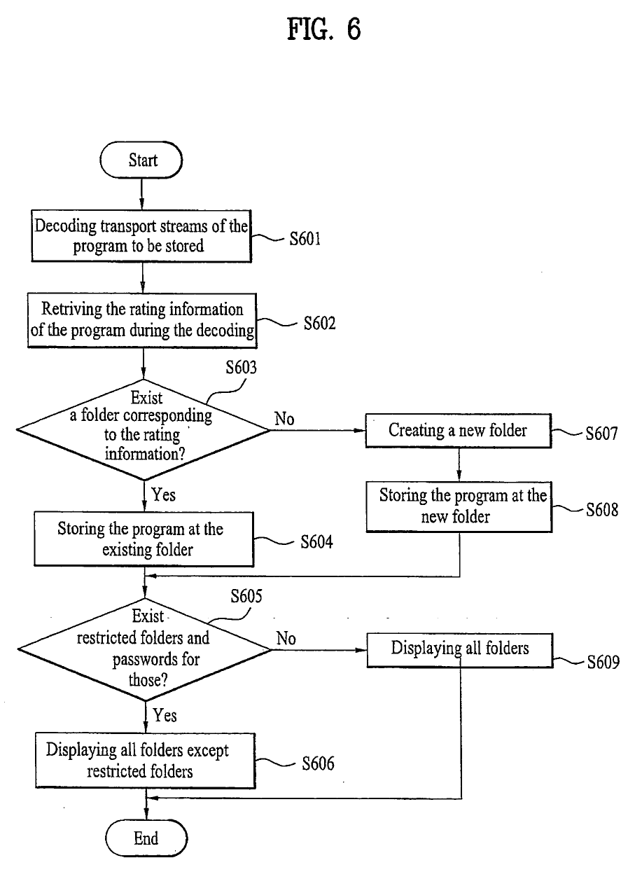

FIG. 5 illustrates a display screen which shows a list of folders for recorded programs without displaying restricted folders. For example, if the list of folders for recorded programs includes “movie,” “drama,” “adult” and “other” as shown in FIG. 3 and the “adult” folder is restricted by the user, the controller (106) controls the display (109) not to display the “adult” folder as shown in FIG. 6. When the correct password is inputted from the user, the controller displays all folders stored at the storage (105).

FIG. 6 illustrates a flowchart illustrating the method steps of automatically classifying recorded programs.

First of all, the decoder (104) decodes transport streams of the program to be stored (S601) and retrieves a rating information of the program to be stored during the decoding (S602). The controller (106) determines whether a folder corresponding to the rating information exists (S603). If the folder corresponding to the rating information exists, the controller stores the program at the existing folder (S604). If the folder corresponding to the rating information does not exist, the controller (S604) creates a new folder and stores the program at the new folder.

After that, the controller determines whether one or more restricted folders exist. If there is a restricted folder, the controller controls the display to display all folders except the restricted folder. If there is no restricted folder, the controller controls the display to display all folders.

While the invention has been described with respect to the physical embodiments constructed in accordance therewith, it will be apparent to those skilled in the art that various modifications, variations and improvements of the present invention can be made without departing from the spirit or scope of the inventions. Thus, it is intended that the present invention covers the modifications and variations of this invention provided they come within the scope of the appended claims and their equivalents.

What is claimed is:

1. A display device for automatically classifying a program to be stored comprising:
a decoder for decoding transport streams of the program to be stored and retrieving a rating information of the program to be stored during the decoding;
a storage for storing the program and the rating information of the program; and
a controller for automatically storing the program according to the rating information.

2. The display device of claim 1, wherein the controller creates a new folder and stores the program at the new folder if a folder corresponding to the rating information does not exist.

3. The display device of claim 1, further comprising a display for displaying the program corresponding to the rating information.

4. The display device of claim 1, further comprising a user input for configuring restricted folders or a password.

5. The display device of claim 4, wherein the controller prevents restricted folders from displaying until the password is entered.

6. A method for automatically classifying a program to be stored comprising:
decoding transport streams of the program to be stored;
retrieving a rating information of the program to be stored during the decoding; and
automatically storing the program according to the rating information.

7. The method of claim 6, further comprising determining whether a folder corresponding to the rating information already exists.

8. The method of claim 7, further comprising storing the program at the folder if the folder already exists.

9. The method of claim 7, further comprising creating a new folder if the folder corresponding to the rating information does not exist.

10. The method of claim 9, further comprising storing the program at the new folder.

11. The method of claim 6, further comprising determining whether a restricted folder or a password is configured.

12. The method of claim 11, further comprising displaying all folders except the restricted folder if the restricted folder or the password is configured.

13. The method of claim 11, further comprising displaying all folders if the restricted folder or the password is not configured.
